(19) United States
(12) Patent Application Publication
(10) Pub. No.: US 2018/0058575 A1
(43) Pub. Date: Mar. 1, 2018

(54) SHIFT-BY-WIRE CONTROL OF VEHICLE TRANSMISSION

(71) Applicant: Ford Global Technologies, LLC, Dearborn, MI (US)

(72) Inventor: Rahat H. KHAN, Rochester, MI (US)

(21) Appl. No.: 15/254,063

(22) Filed: Sep. 1, 2016

(51) Int. Cl. F16H 61/04; F16H 61/02

(52) U.S. Cl. CPC F16H 61/0437; F16H 61/0213

(57) ABSTRACT

A vehicle includes a transmission and an associated shift by wire module that is configured to output requests to shift the transmission into various operating modes, such as park, neutral, reverse, etc. A sensor is configured to output noise, vibration, and harshness (NVH) signals during operating mode changes. During a first operating mode change, a first delay is realized between the request being received and the operating mode actually being changed. The NVH associated with that operating mode change is recorded and stored in a storage device. During a subsequent second operating mode change, a second delay is realized between the request being received and the operating mode actually being changed. The second delay is modified or reduced based on the stored NVH of the first mode change.

### TECHNICAL FIELD

This application generally relates to a system for managing driver-requested gear changes (modes of operation such as park, neutral, etc.) in a vehicle powertrain.

### BACKGROUND

Shifting a transmission into various modes (e.g., Park, Reverse, Neutral, and Drive) has been traditionally accomplished by mechanical links to put the vehicle in the drive modes via a lever mounted on the steering column or a gear shifter near the center console. More recently, vehicles have become equipped with shift by wire (SBW) systems in which the transmission modes are engaged/changed via electronic controls without any mechanical linkage between the gear shifting lever and the transmission. SBW systems eliminate space required for housing the mechanical linkages between the shifter and the transmission.

One type of SBW system includes a push-button panel in which multiple buttons are provided, each button corresponding to a desired transmission mode. For example, if the operator depresses a button corresponding to a Park mode (e.g., “P”), a request would be sent to the control system to place the vehicle in park. The request is fulfilled assuming other conditions are met, such as the vehicle being motionless and the brake pedal being applied. Another type of SBW system includes a rotary shifter in which the operator rotates a knob to the desired transmission mode.

### SUMMARY

According to one embodiment, a vehicle includes a shift by wire (SBW) module configured to output requests to shift a transmission into various operating modes. A sensor is configured to output noise-vibration-harshness (NVH) signals during operating mode changes. At least one controller is programmed to, in response to the requests, command operating mode changes after a delay. The at least one controller is further programmed to modify a duration of the delay based on the NVH signals associated with previous operating mode changes.

In another embodiment, a method includes the following steps: shifting a transmission into various operating modes based on requests received from a shift by wire (SBW) module, outputting NVH signals during changes in operating modes, performing a first change in operating modes after a first delay from receiving an associated request from the SBW module, and performing a second change in operating modes after a second delay that is reduced based on NVH signals received during the first change.

In yet another embodiment, a powertrain includes a transmission configured to shift operating modes in response to a command from a shift by wire (SBW) module. At least one controller is programmed to request a mode shift in the transmission via a control area network (CAN) in response to receiving the command from the SBW module, and control a delay between receiving the command and requesting the mode shift based on received signals from an NVH sensor and CAN data.

### BRIEF DESCRIPTION OF THE DRAWINGS

FIG. 1 is a perspective view of a shift-by-wire system in a vehicle, according to one embodiment.

FIG. 2 is a schematic of a control system of the shift-by-wire system, according to one embodiment.

FIG. 3 is front view of an interior of the vehicle in which the steering wheel is provided with paddle shifters to request gear changes, according to one embodiment.

FIG. 4 is a schematic data flow diagram illustrating NVH signals and CAN data being combined by a controller to optimize a delay between a requested gear change and an actual gear change, according to one embodiment.

FIG. 5 is a plot of the NVH signals and CAN data signals on an overlapping scale, according to one implementation of a transmission control according to one embodiment.

FIG. 6 is another plot of NVH signals and CAN data signals on an overlapping scale according to another implementation of a transmission control according to another embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Many vehicles are used over a wide range of vehicle speeds, including both forward and reverse movement. Some types of engines, however, are capable of operating efficiently only within a narrow range of speeds. Consequently, a transmission may be capable of efficiently transmitting power at a variety of speed ratios. When the vehicle is at low speed, the transmission can be operated at a high speed ratio such that it multiplies the engine torque for improved acceleration. At high vehicle speed, operating the transmission at a low speed ratio permits an engine speed associated with quiet, fuel efficient cruising.

A transmission according to the present disclosure may be mounted to the vehicle structure, with an input of the transmission being driven by an engine crankshaft, often via a launch device such as a torque converter, and an output driving the vehicle wheels, often via a differential assembly which permits the left and right wheel to rotate at slightly different speeds as the vehicle turns. The transmission may be equipped with various subsets of the clutches and brakes to be engaged to establish the various speed ratios. The transmission may thus be referred to as a discrete step-ratio transmission as it is configured to shift between multiple, discrete, stepped gears that each has a different input-to-output speed ratio.

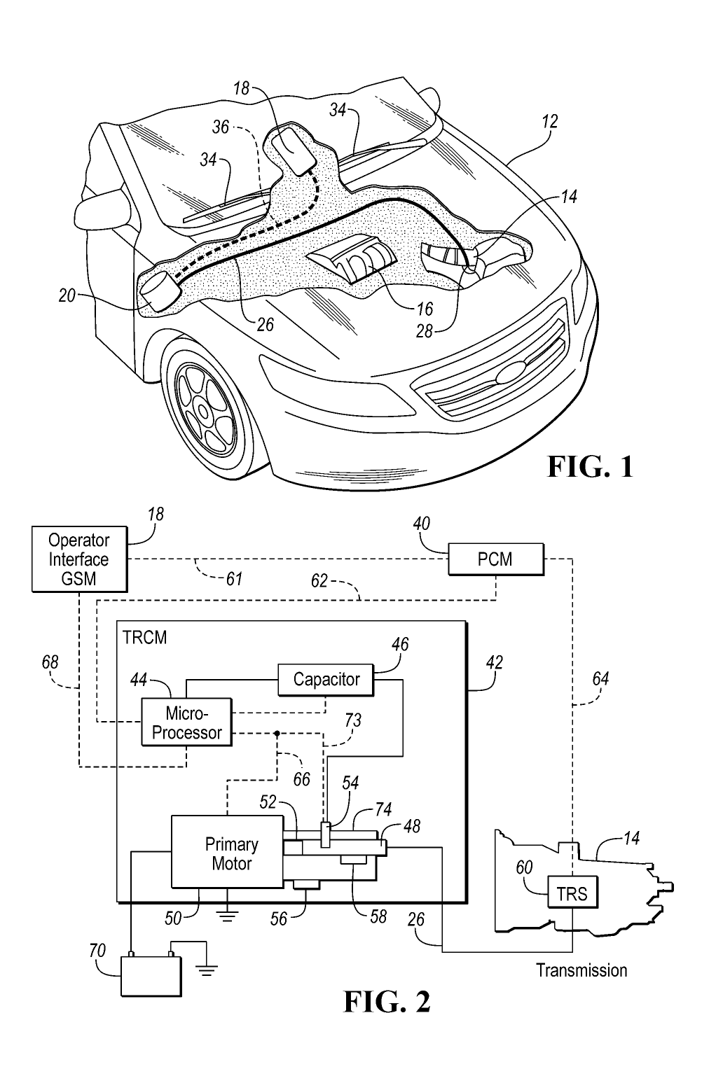

Referring now to the drawings, FIGS. 1 and 2 show the components of a shift-by-wire system 10 installed in preferable locations in a motor vehicle 12. The vehicle operator selects a desired transmission operating range among the conventional ranges, which may include, without limitation, Park (P), Reverse (R), Neutral (N), Drive (D), and Low (L), corresponding respectively to Park, Reverse, Neutral, Drive and Low operating ranges. The system causes a multiple-speed automatic transmission 14 to shift to the selected operating range. The vehicle's powertrain includes a power source 16, such as an internal combustion engine, driveably connected to the transmission 14.

The system 10 includes an actuator assembly 20 secured at any convenient place in the vehicle 10, such as in the underhood engine compartment, the interior of the vehicle, on the transmission 14 itself, or on the vehicle's chassis.

In one embodiment, longitudinal displacement produced by rotary movement of the actuator assembly's output lever is transmitted along a shift cable 26 to a manual valve 28 of the transmission's hydraulic control system to the position that corresponds to the selected transmission operating range. The position of manual valve 28 connects a pressurized portion of the transmission's hydraulic system to a circuit that produces the selected operating range.

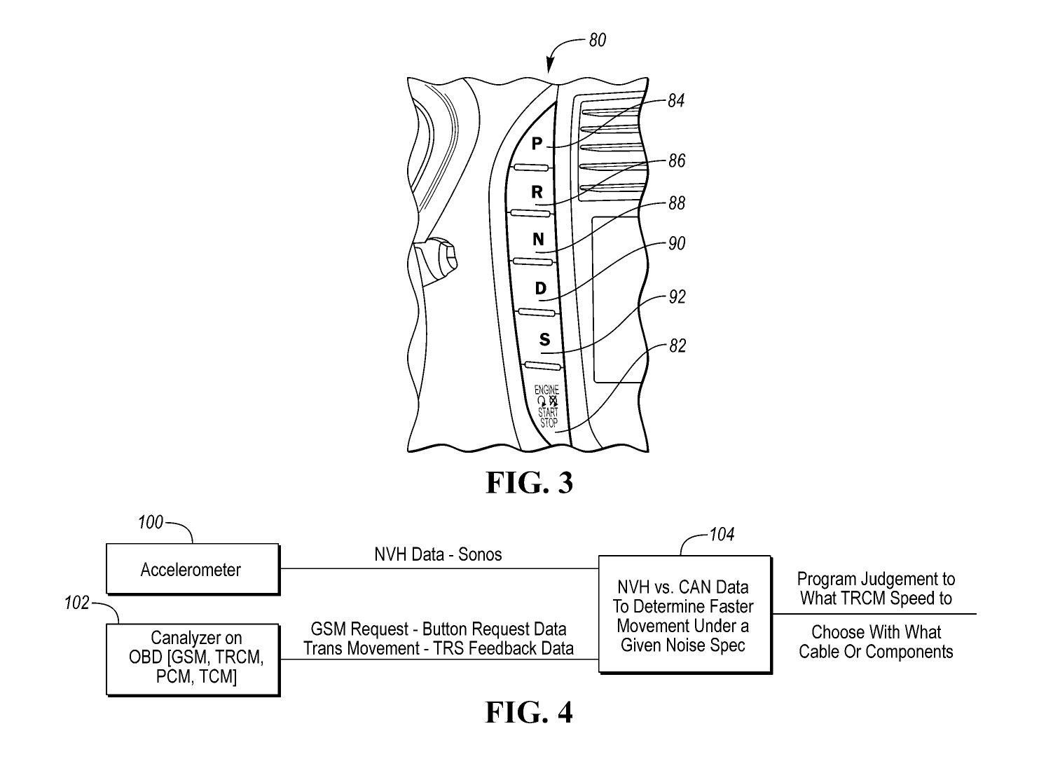

One embodiment of a driver interface of the system 10 is a shifter switch 18, located in the passenger compartment on or near the vehicle's instrument panel. Shifter switch 18 produces a signal representing the selected transmission operating range (e.g., PRNDL), and the shift cable 26 moves the transmission's manual valve 28 in response to the signal produced as output by shifter switch 18. In one embodiment, the shifter switch 18 is push-button shift panel, as shown in FIG. 3 and explained below. The shifter switch can also be referred to as a shift-by-wire (SBW) module.

FIG. 2 illustrates one embodiment of the arrangement of the components of the system 10, which includes the SBW module 18 (or gear shift module, GSM), a powertrain control module (PCM) 40, and a transmission range control module (TRCM) 42, which incorporates primary and secondary actuators of the actuator assembly 20. A microprocessor 44 is also provided, coupled to a capacitor 46. The transmission 14 includes a transmission range sensor (TRS) 60 configured to output a signal representing the transmission range (PRNDL). The actuator 20 includes an on-board sensor 56 that, like the TRS 60, provides feedback on line 64 as a check on the current transmission operating range compared to the driver-selected range and TRCM 42 position. Inner and outer members 48, 74 are illustrated in the form of hollow cylinders, each having an open axial end.

Sensors 56, 58 are Hall-type position sensors, which produce signals representing the presence and absence of the sensed component at a reference position. Sensor 56 is a position sensor on the outer member 74. A signal produced by sensor 56 and carried on line 66 is used by the microprocessor 44 to verify that the angular position of an output lever is correct relative to the desired, selected transmission operating range produced in response to the operator's manual control of the SBW module 18. A signal produced by sensor 58 and carried on line 66 is used by microprocessor 44 to verify that secondary output mechanism is functioning correctly.

Electronic signals produced by SBW module 18 are carried on line 61 to the PCM 40. Electronic signals produced by the PCM 40 are carried on line 62 to the microprocessor 44 of the TRCM 42.

During normal operation, a secondary release motor 54 allows piston 48 to latch to a primary motor 50, thereby allowing piston 48 to move leftward and rightward among each transmission range in response to the signal produced by the SBW module 18. The transmission is shifted accordingly.

It should be understood that one or more of the control modules and processors described above can be referred to as a controller.

FIG. 3 shows an interior of the vehicle including SBW module 18. In this embodiment, the particular selector switch is a push-button shift panel 80. The push-button shift panel 80 is located adjacent to or incorporates an engine start/stop button 82 that enables the driver to stop and start the engine (or other power source, if the vehicle is a hybrid vehicle, electric vehicle, or is powered by fuel cell, or the like). The push-button shift panel 80 includes a plurality of depressible buttons for shifting the drive mode of the vehicle or transmission. The term “drive mode” should be understood to mean a transmission mode or the like that alters the state of the transmission and powertrain from park, reverse, neutral, drive, and other optional modes. Such drive modes are commonly referred to as the PRND or PRNDL, acronyms referring to the park/reverse/neutral/drive/low modes. A park button 84 (“P”) enables the vehicle or transmission to be placed in park. A reverse button 86 (“R”) enables the vehicle or transmission to be placed in reverse. A neutral button 88 (“N”) enables the vehicle or transmission to be placed in neutral. A drive button 90 (“D”) enables the vehicle or transmission to be placed in drive. A sport button 92 (“S”) enables the vehicle or transmission to be placed in a sport mode.

While FIG. 3 illustrates a push-button shift panel, it should be understood that a push-button shift panel is but one example of a SBW module. In another embodiment, the push-button shift panel is replaced by a rotary shifter. Other shift-by-wire or selector switches are known for providing electronic shifting between drive modes.

Referring back to FIG. 2, when the SBW module (or GSM) 18 receives a request to shift operating modes, the SBW module (or GSM) 18 sends a command to the TRCM 42 to shift the transmission through the shift cable. A delay may exist between the moment the SBW module 18 sends the request to shift modes, and the actual shifting of gears. This delay accounts for the time for, among other things, the control system to check to see if a shift can be safely performed given the vehicle speed, the transmission input/output speed, etc. If this delay is reduced to speed up the shift process, there is a potential for noise, vibration and harshness (NVH) to increase due to metal-on-metal grinding within the TRCM, metallic shifter cable movement, and/or transmission output manual lever (OML) movement. A shortened delay, while maintaining or controlling the NVH due to these components, can provide a durable and quiet ride.

According to various embodiments of this disclosure, the control system of the vehicle controls the delay between a request to shift drive modes and the actual shift of drive modes based on signals that represent NVH from these (or other transmission) components. FIG. 4 represents data flowing from an accelerometer representing NVH, and data flowing from or through a control area network (CAN) relating to the requested shift. In one embodiment, the NVH signals are compared to or overlapped with signals flowing through the CAN to allow a controller to yield an optimum delay time between the request to shift gears and the actual gear shift.

FIG. 4 illustrates a schematic of an algorithm and representation of data flow within the system. One or more accelerometers 100 are mounted to one or more associated components. The accelerometers are configured to detect acceleration of the component, and output signals that represent NVH (e.g., acceleration) of that component. One or more of the GSM, TRCM, PCM and TCM (transmission control module configured to operate and modulate the transmission) are configured to communicate over a CAN 102. One or more of the controllers described above, and/or one or more additional controllers is represented by 104. This controller 104 is programmed to compare the NVH signals and the CAN data signals as will be described below. The comparison of the NVH signals and the CAN data signals allow the controller to command to the TRCM what speed the input to the transmission should be and control the necessary structure to produce the desired speed.

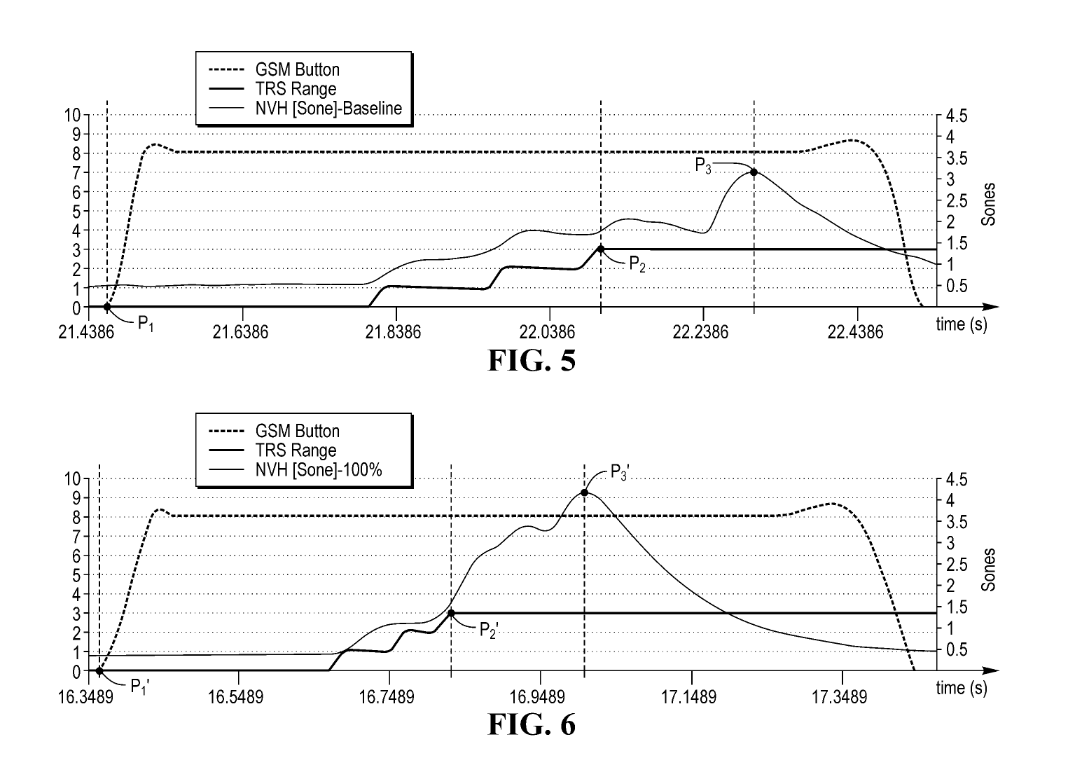

FIG. 5 illustrates a plot over time of the activity occurring in the transmission and transmission control system. The GSM button (e.g., one of the buttons on the push-button shift panel 80) is depressed at point P₁, indicating a desire to shift modes. At this time, the TRS 60 outputs a magnitude of 0. The TRS 60 runs a check to see what operating gear (P, R, N, D, L) the transmission is currently operating in. The change in the TRS output from 0 to 3 is indicative of the checks to assure the transmission is not in Park, Reverse, or Neutral, for example. The controller will not command a shift in drive modes from Drive to Sport unless a signal is received from the TRS that indicates that the vehicle is not in Park, Reverse, or Neutral, for example. In the embodiment shown in FIG. 3, the controller commands a shift into the next gear when the TRS 60 outputs a magnitude of 3, indicating the vehicle is either in Drive or Sport.

A command to change gears is then issued from the TRS and TRCM via the CAN, illustrated at point P₂. P₂ is shown in FIG. 5 to be approximately at t=22.1179 seconds. But, it is not until point P₃ (t=22.9998 seconds) that the peak of the actual gear shift is realized, which can be seen by the peak in the NVH output signal due to metal-to-metal grinding within the TRCM, metallic shifter cable movement, and/or transmission output manual lever movement. In this embodiment, the peak of the NVH output is approximately 3.14 sones. The difference in time between point P2 and point P3 (i.e., the difference between a commanded shift to the peak NVH of the actual shift) in this embodiment is approximately t=0.8819 seconds. The NVH signals associated with gear change can be recorded or stored in an on-board storage device or, alternatively, by an off-board storage device utilizing cloud computing.

FIG. 6 illustrates another plot over time of the activity occurring in the transmission and transmission control system. In this plot, the control system issues a command to shift gears more quickly after receiving the command from the paddle shifter, as compared to the plot of FIG. 5. The peak NVH signal output is shown at point P₃′ which is approximately 4.11 sones. The increase in noise is due to a quicker accumulation of the metal-to-metal grinding within the TRCM, metallic shifter cable movement, and/or transmission output manual lever movement during the quicker gear shift. However, 4.11 sones remains within specification for maximum acceptable noise (i.e., below a maximum allowable NVH threshold).

Once again, point P₁′ represents the moment in which the SBW module commands a shift in operating modes. A mode shift command is not sent until point P₂′, once the TRS indicates that the vehicle is not in Park, Reverse, or Neutral. The delay between the gear shift command being acceptable or issued at point P₂′ and the requested gear shift from the paddle shifter at point P₁′ is approximately t=0.6602 seconds. This is compared to a delay of t=0.461 seconds between points P₂ and P₁ in FIG. 5. The TRS output is commanded to more rapidly check for which gear selection is made, which reduces the delay between the requested gear shift and the actual gear shift command being issued. In other words, the signals output from the TRS can remain on a discrete output (e.g., 0, 1, or 2) for a shorter period of time such that the output of 3 (representing “Drive” or “Low”) is reached more rapidly.

The difference between point P₃′ (i.e., the peak of the noise indicating the actual gear shift) and point P₂′ (i.e., the issued command to shift gears) is t=0.177 seconds. This is compared to the similar delay between points P₃ and P₂ (FIG. 5) of t=0.1819 seconds.

The overlap of the NVH signals and the data flowing through the CAN allows for a comparison of the optimum delay in requested mode shift and actual mode shift while still maintaining an acceptable NVH (sones). For example, as shown in FIG. 5, the overall delay from the time in which the shift is requested at point P₁ to the time in which the actual gear shift occurs at point P₃ is approximately t=0.8421 seconds. A maximum NVH output is realized as 3.14 sones. However, the controller and control system can decrease the delay while maintaining acceptable NVH, as shown in FIG. 6, in which the overall delay from the time in which the shift is requested at point P₁′ to the time in which the actual mode shift occurs at point P₃′ is approximately t=0.638 seconds. Therefore, the delay has been reduced by 0.2041 seconds. This is made possible by combining the NVH signal with the CAN signals on the same scale or resolution to compare different combinations of mechanical and physical design changes with software calibration changes to find the optimized delay while maintaining acceptable NVH magnitudes. The optimized delay may be the shortest delay that still maintains acceptable NVH magnitudes.

While the comparison between the NVH signals with the CAN data is shown can be from shifting from Drive to Sport, the comparison can also be done when shifting to any other gear or shift mode.

One or more algorithms can be programmed into the controller for controlling the gear or mode shifts described above. One example of an algorithm is as follows. The controller receives data regarding NVH observed over a plurality of shifts (e.g., from neutral to drive). During those shifts, the controller would alter the delay. During a first shift, after a first delay which produces a first NVH magnitude, the controller stores the information relating to that shift (e.g., the delay, the resulting NVH, etc.). Then, the controller alters the delay for a second shift. During that second shift with a second delay, a second NVH magnitude would result. The controller stores the information relating to that second shift. The process repeats for a third shift and subsequent shifts, with a plurality of data or information being stored with respect to each shift, showing different delays and different resulting NVH magnitudes. The controller can then determine which of the delays is the shortest possible delay while still yielding a NVH magnitude that is within a given specification or NVH threshold. The controller can then use that delay as the baseline delay for future shifts.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A vehicle comprising:
a shift by wire (SBW) module configured to output requests to shift a transmission into various operating modes;
a sensor configured to output noise-vibration-harshness (NVH) signals during operating mode changes; and
at least one controller programmed to
in response to the requests, command operating mode changes after a delay, and
modify a duration of the delay based on the NVH signals associated with previous operating mode changes.

2. The vehicle of claim 1, further comprising transmission range sensor (TRS) configured to output data in response to the request for the shift, wherein the at least one controller is programmed to compare the NVH signal with the TRS data.

3. The vehicle of claim 2, wherein the at least one controller is further programmed to optimize the delay based on the comparison of the NVH signal and the TRS data.

4. The vehicle of claim 3, wherein an optimized delay is based on a maximum acceptable NVH magnitude such that the delay is optimized while maintaining the NVH signal below the maximum acceptable NVH magnitude.

5. The vehicle of claim 2, wherein the at least one controller is programmed to modify the duration of the delay by causing an increase in speed of an operation of the TRS.

6. The vehicle of claim 2, further comprising a transmission operating range sensor (TRS) configured to output a signal representing a current operating range of the transmission, wherein the at least one controller is further programmed to command the operating mode changes based on the transmission operating range sensor indicating the vehicle is not in park.

7. The vehicle of claim 6, wherein the at least one controller is further programmed to reduce the duration the delay by reducing an amount of time that the TRS outputs various signals representing various operating ranges of the transmission.

8. The vehicle of claim 1, wherein the SBW module includes a push-button shift panel with a plurality of buttons, each button configured to shift the transmission into a respective operating mode.

9. A method comprising:
shifting a transmission into various operating modes based on requests received from a shift by wire (SBW) module;
outputting NVH signals during changes in operating modes;
performing a first change in operating modes after a first delay from receiving an associated request from the SBW module; and
performing a second change in operating modes after a second delay that is reduced based on NVH signals received during the first change.

10. The method of claim 9, further comprising optimizing the second delay based on a comparison of the NVH signals and the duration of delays of multiple changes in operating modes.

11. The method of claim 10, wherein the optimizing includes maintaining the NVH signal below a maximum NVH threshold.

12. The method of claim 9, further comprising transmitting various transmission operating range signals that each represent a respective transmission operating range, and wherein the first and second change in operating modes occurs is in response to receiving one of the transmission operating range signals.

13. The method of claim 12, wherein the second delay is reduced by reducing an amount of time between transmitting of the various operating range signals.

14. A powertrain comprising:
a transmission configured to shift operating modes in response to a command from a shift by wire (SBW) module; and
at least one controller programmed to request a mode shift in the transmission via a control area network (CAN) in response to receiving the command from the SBW module, and control a delay between receiving the command and requesting the mode shift based on received signals from an NVH sensor and CAN data.

15. The powertrain of claim 14, wherein the CAN is configured to transmit data in response to the request of the mode shift, and the at least one controller is programmed to compare the NVH signal with the CAN data.

16. The powertrain of claim 14, wherein the at least one controller is further programmed to optimize the delay based on the comparison of the NVH signal and the CAN data.

17. The powertrain of claim 16, wherein an optimized delay is based on a maximum acceptable NVH such that the delay is optimized while maintaining the NVH signal below the maximum acceptable NVH magnitude.

18. The powertrain of claim 14, further comprising a transmission operating range sensor configured to output various signals representing various operating ranges of the transmission.

19. The powertrain of claim 18, wherein the at least one controller is further programmed to reduce the delay by reducing an amount of time between the transmission operating range sensor outputting a first of the various signals and a second of the various signals.
